(19) United States
(12) Patent Application Publication
(10) Pub. No.: US 2005/0275641 A1
(43) Pub. Date: Dec. 15, 2005

(54) Computer monitor

(76) Inventor: Matthias Franz, Altdorf (DE)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/407,949

(22) Filed: Apr. 7, 2003

(51) Int. Cl. G09G 5/00

(52) U.S. Cl. 345/204

(57) ABSTRACT

A computer monitor comprises an input for at least first and second computer video signals. First and second of the video signals are respectively assigned to main and auxiliary pictures that are simultaneously applied to a single display.

### FIELD OF THE INVENTION

The present invention relates to computer monitors and methods of displaying computer video signals.

### BACKGROUND ART

Dual input computer monitors, such as the HP A 4331 A and the Sony Multiscan 6420, enable a user to connect the video outputs of two separate personal computers to a single monitor. Usually such dual input computer monitors have an input selection switch to select one of the video signals derived by the two different computers for display on the monitor.

For example, a user can select the video output signal of one of the computers for display on the dual input monitor in order to work with an application running on that computer. Another application can run on the other computer in parallel. When the user needs to check the status of the parallel process he or she can operate the input selection switch to display the video output of the other computer running the parallel process.

An alternative way to couple multiple personal computers to a single computer monitor is by means of a so-called KVM (keyboard, video, mouse) switch. A KVM switch eliminates the need for separate input peripheral devices for each of the multiple personal computers. In addition to controlling multiple personal computers from the same keyboard, mouse and monitor, some KVM switches enable connecting of other USB peripherals for all of those personal computers by a USB hub. Such KVM switches are also referred to as KVMP switches, where the ‘P’ is for peripheral. KVM and KVMP switches are commercially available from IOGEAR, Inc (www.ioaear.com) and others.

Such a KVM or KVMP switch a single input computer monitor can be selectively coupled to one of a plurality of personal computers which are connected to the switch. The user can change the personal computer to which the single input monitor is coupled by inputting a control command. For example the personal computer to which the computer monitor is to be coupled is selected by special keyboard ‘hotkeys’ (e.g. unusual combinations of keystrokes). Alternatively the address of the selected personal computer can also be determined by mechanical switches which are directly connected to a controller of the KVM or KVMP switch.

A common disadvantage of dual input computer monitors and KVM/KVMP switches is that at any given point of time only a single computer video output can be displayed. This is inconvenient especially when the user needs to monitor a parallel process running on one of the computers because the user needs to switch back and forth between the video outputs derived by the computers to check the status of the parallel process. This can distract a user from his or her main work task and reduce his or her productivity. A further disadvantage is that when the status of the parallel process requires user action, the need for user action is not immediately recognized by the user until the user inputs the switch command to check the status of the parallel process.

Many modem television receivers have two tuners for receiving two different television signals at the same time. Such television sets include the ability to display a small auxiliary image in addition to a larger main image for simultaneous display of the two television programs. The smaller auxiliary image is typically displayed within the boundaries of the larger main picture, in which case, such a television system is termed a picture-in-picture (PIP) system, or the smaller auxiliary image can be located outside (e.g. to the left or right side of the main image), in which case the system Is termed a picture-outside-picture (POP) system. Such PIP and POP television systems are known from U.S. Pat. No. 4,623,915, U.S. Pat. No. 5,598,222, U.S. Pat. No. 5,237,246, U.S. Pat. No. 6,008,860, U.S. Pat. No. 6,307,597 and European Patent Application No. 0550911 A1. Such prior art television systems cannot be coupled to multiple computers.

### SUMMARY OF THE INVENTION

One aspect of the present invention is directed to a computer monitor which can (1) be coupled to at least two computers and (2) simultaneously display at least a first picture from the video signal of one of the computers and a second picture from the video signal of the other computer. The combined simultaneous display of the first and second pictures enables the user to monitor a parallel process on the second picture while continuously working with an application being displayed in the first picture.

This is particularly advantageous because the user can immediately recognize the status of the parallel process which requires user interaction. This is in contrast to the prior art where the user needed to switch back and forth between the computer video outputs to check the status of the parallel process from time to time. In addition, the present invention enables the user to work with the application which is visualized on the main picture without interrupting his/her work to check the status of the parallel process.

In accordance with a preferred embodiment of the invention a plurality of pictures can be displayed on a single display at the same time. Each of the pictures is based on a video output signal of one computer of a plurality of computers which are connected to the computer monitor. One of the plurality of pictures is the main picture. For example, the main picture differs from the other pictures as a result of input actions performed by the user that are related to the main picture and inputted into the computer that derives the video signal for generating the main picture.

In accordance with a further preferred embodiment of the invention, a mechanical input selection switch is provided on the housing of the computer monitor. By operating the input selection switch the user can designate one of the computers which is connected to the computer monitor as the main picture. For example, the input selection switch is arranged in the vicinity of screen-control switches or other control knobs which enable the user to adjust various characteristics, such as color and contrast; of the computer monitor.

In accordance with a further preferred embodiment of the invention, the computer monitor has a picture-in-picture and a picture-outside-picture display modes. In the picture-in-picture display mode the auxiliary image(s) is displayed within the boundaries of the larger main picture. In the picture-outside-picture display mode the auxiliary picture(s) is located outside the main picture. For example a display mode selection switch is provided next to the input selection switch.

In accordance with a further preferred embodiment of the invention at least one computer peripheral is connected to the computer monitor rather than to one of the computers. The connection between the computer peripheral and one of the plurality of computers connected to the computer monitor is established through a switch of the computer monitor. For example the computer peripheral is a computer mouse and/or a computer keyboard and/or another input device. These input devices are directly connected to the computer monitor. The input devices are selectively coupled to one of the computers connected to the computer monitor. This arrangement makes it possible to control the multiple computers which are connected to the computer monitor from a single set of input devices. Preferably such control is realized by a KMV or KMVP type switch which is integrated into the computer monitor.

In accordance with a further preferred embodiment of the invention, the KMV or KMVP switch is controlled by mechanical switch control knobs. Alternatively the switch is controlled from the input devices. For example a set of function keys or hot keys is defined on a keyboard; the keys correspond to defined settings of the switch. By pressing such a function or hot key on the keyboard the user can control the assignment of the set of input devices, for example computer mouse and keyboard, to one of the plurality of the computers connected to the computer monitor.

When such an input action is performed by the user, the KMV or KMVP type switch also generates a control signal for assigning the video output of the selected computer to the main picture. This arrangement enables the input devices, as well as the main picture, to be assigned to the same computer. Assigning the input devices and the main picture to the same computer enables a user to actively work with an application running on the selected computer, for example by clicking on objects shown in the main window and/or by inputting data through the keyboard; these inputs are shown in the main picture. While the user is doing this he or she can at the same time check the status of the processes running on the other computers which appear on the auxiliary pictures.

### BRIEF DESCRIPTION OF THE DRAWING

In the following, preferred embodiments of the invention are described, by way of example, and with reference to the drawings in which:

FIG. 1 is a diagram including a computer monitor having a picture-in-picture display in combination with a pair of computers,

FIG. 2 is a block diagram of the computer monitor of FIG. 1,

FIG. 3 is a flow chart of operations performed by the apparatus of FIG. 1 for generating combined main and auxiliary pictures,

FIG. 4 is a block diagram of a computer monitor having an integrated KVM type switch, and

FIG. 5 is an illustration of a computer monitor operating in picture-outside-picture mode.

### DETAILED DESCRIPTION OF THE DRAWING

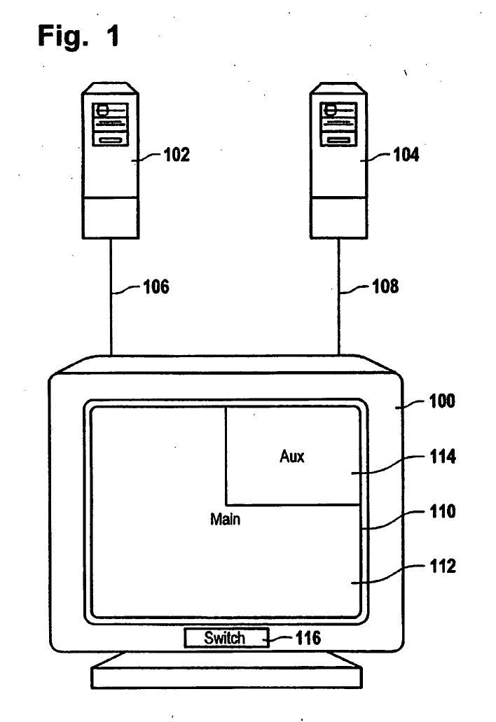

The apparatus of FIG. 1 includes computer monitor 100 having at least two video inputs connected to be responsive to the video outputs of personal computers 102 and 104. For example the video outputs of computers 102 and 104 are coupled to the respective video inputs of computer monitor 100 by means of cables 106 and 108. Alternatively wireless links can be used in order to couple the video outputs of computers 102 and 104 to the respective video inputs of computer monitor 100, such as by means of infrared or radio frequency wireless data transmission.

Computer monitor 100 has display region 110 which is separated into main picture 112 and auxiliary picture 114. Auxiliary picture 114 is displayed within the boundaries of the larger main picture 112. In other words, the computer monitor 100 is in a picture-in-picture display mode.

Further, computer monitor 100 has input mechanical control switch 116 disposed in the housing of computer monitor 100 such that a user can operate the input control switch 116, which is, for example, a rocker switch.

By operating input control switch 116, a user controls the assignment of the video outputs of the computers 102 and 104 to the main pictures 112 and 114. When the left side of the input control switch 116 is depressed the video output of computer 102 is assigned to the main picture 112 while the video output of computer 104 is assigned to the auxiliary picture 114. In order to change this assignment of the video outputs of the computers 102 and 104, the right side of input control switch 116 is depressed by the user. In response to depressing the right side of input control switch 116 video output of computer 104 is assigned to the main picture 112 while the video output of computer 102 is assigned to auxiliary picture 114.

For example, assume the user has depressed the left side of input control switch 116, such that the video output of computer 102 is assigned to main picture 112 and video output of computer 104 is assigned to auxiliary picture 114. This enables the user to work with an application program running on computer 102 the output of which is shown on main picture 112, while monitoring a parallel process running on computer 104. The output of the parallel process is shown in auxiliary picture 114, which enables the user to permanently check the status of the parallel process without performing an input action and without having to interrupt his or her work with the application running on computer 102.

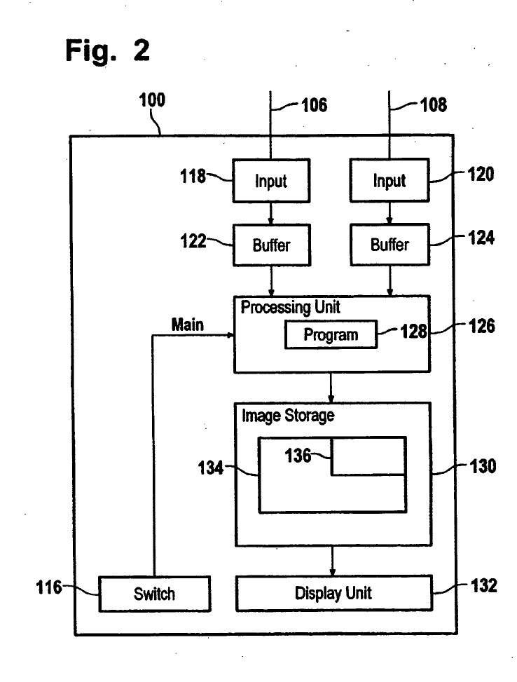

FIG. 2 is a block diagram of apparatus included in computer monitor 100 of FIG. 1. The cables 106 and 108 are connected to respective inputs 118 and 120 of computer monitor 100. Video buffers 122 and 124 are coupled to respective ones of the inputs 118 and 120. Processing unit 126, including a memory storing program 128, can access video buffers 122 and 124 for processing of the video signals. Unit 126 processes the video signal in response to program 128. Alternatively the functionality of program 128 can be realized by logic circuitry. For example processing unit 126 can be a general purpose processing unit or a digital signal processor.

The output of processing unit 126 is coupled to image storage 130. Image storage 130 is a frame buffer for holding a complete bit-mapped image that is displayed on display unit 132 and which is coupled to image storage 130.

Input control switch 116 is coupled to processing unit 126 for inputting of the ‘main display’ signal into processing unit 126 for selecting one of the video signals as the main video signal for generating main picture 112 (cf. FIG. 1)

In operation separate computer video signals are received via cables 106 and 108 at inputs 118 and 120, respectively; the video signals are then buffered in video buffers 122 and 124, respectively. By depressing switch 116 to the left or the right a user can select the video signal received via cable 106 or the other video signal received via cable 108 as the main video signal for generating the main picture data. Program 128 enables processing unit 126 to generate the bit-mapped main picture data, which is stored in storage area 134 of image storage 130 as well as the bit-mapped auxiliary image data which is stored in storage area 136 of image storage 130. The combined image data stored in storage areas 134 and 136 is displayed on display unit 132 as illustrated in FIG. 1.

It is to be noted that display unit 132 can be of any type, such as a cathode ray tube (CRT) display, or a liquid crystal display (in particular, a thin-film transistor (TFT) display) or another active matrix display, such as an organic thin-film transistor display.

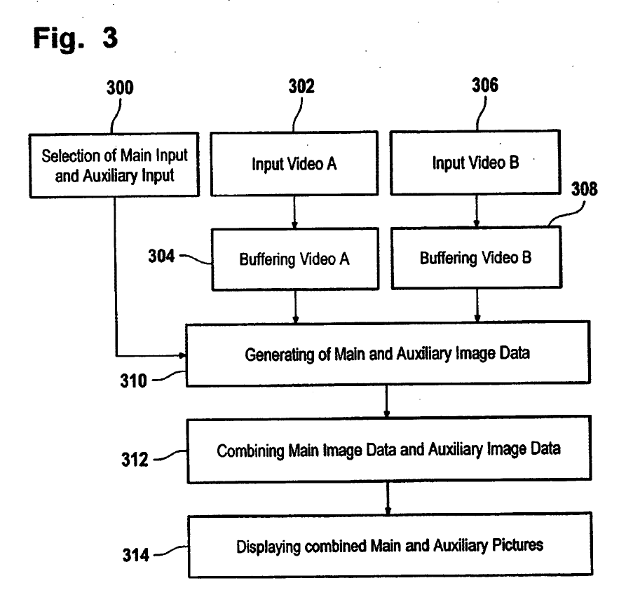

FIG. 3 is a flow chart of the operations processing unit 126 performs in response to program 128 to control image storage 130. In step 300 unit 126 makes a selection between two video inputs, A and B of a computer monitor. The selected one of the video inputs A and B is the main input, the other one is the auxiliary input.

In step 302 unit 126 enables a computer video signal to be received at the video input A of the computer monitor. Unit 126 supplies this video signal to the appropriate buffer 122 or 124 in step 304.

In parallel, processing unit 126 causes a second computer video signal to be received at video input B of the computer monitor in step 306 and the video signal received at video input B is supplied to the other buffer in step 308.

In step 310 processing unit 126 causes main image data generated from the video signal input which has been selected as the main input to be coupled to main storage area 134 from the appropriate buffer. For example if the video input A has been selected as the main input in step 300, corresponding main image data is coupled from buffer 122 and stored in area 34 during step 310 on the basis of the video signal buffered in step 304. Likewise auxiliary image data in buffer 124 is stored in area 136 during step 310 on the basis on the video signal buffered in step 308.

In step 312 processing unit 126 causes the main image data in area 134 and the auxiliary image data in area 136 to be combined in order to form a single stored image 130. This can be accomplished by storing the bit-mapped main image data and the bit-mapped auxiliary image data in a common frame buffer.

In step 314 processing unit 126 causes the data stored in the frame buffer to be displayed to provide simultaneous display of the combined main and auxiliary pictures.

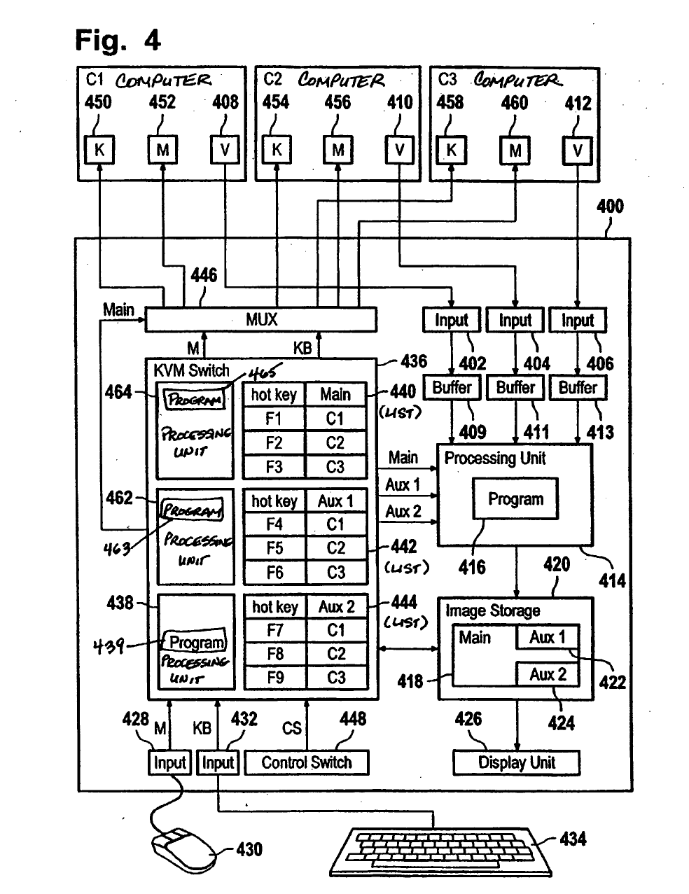

FIG. 4 is a block diagram of a computer monitor 400 having inputs 402, 404 and 406 for receiving respective computer video signals from video outputs 408, 410 and 412 of computers C1, C2 and C3, respectively. The video output signals of the computers C1, C2 and C3 are typically standard VGA video signals.

The inputs 402, 404 and 406 are coupled to respective video buffers 409, 411 and 413. Processing unit 414 accesses video buffers 409, 411 and 413 for processing of the video data under the control of program 416 which the processor stores in its memory.

Processing unit 414 responds to program 416 to generate bit-mapped main picture data and auxiliary picture data for auxiliary pictures ‘Aux1’ and ‘Aux2’. Processing unit 414 responds to program 416 to cause the main picture data to be stored in storage area 418 of frame buffer 420 and the picture data for auxiliary picture ‘Aux1’ to be stored in storage area 422 and picture data for auxiliary picture ‘Aux2’ to be stored in storage area 424 within frame buffer 420. Processing unit 414 responds to program 416 to output the resulting combined image comprising the main picture and the auxiliary pictures ‘Aux1’ and ‘Aux2’ to display unit 426 which is coupled to frame buffer 420.

Input 428 or computer monitor 400 connects computer mouse 430 to computer monitor 400. Input 432 of computer monitor 400 connects keyboard 434 to computer monitor 400. Further inputs for coupling additional computer peripherals and input devices to computer monitor 400 can be provided.

By means of inputs 428 and 432, computer mouse 430 and keyboard 434 are coupled to KVM switch 436. KVM switch 436 receives signal ‘M’ from input 428; input signal ‘M’ is the input signal provided to computer monitor 400 by mouse 430. Likewise KVM switch 436 receives input signal ‘KB’ from input 432 which is the input signal provided by keyboard 434.

KVM switch 436 includes processing unit 438 with a memory storing its (1) control program 439 and (2) lists 440, 442 and 444. By means of the lists 440, 442 and 444, hot keys F1, F2, F3, . . . F8, F9 on keyboard 434 are defined. List 440 defines the hot keys for selection of the main video source; for example, depression of hot key F1 causes processing unit 438 to select computer C1 as the source of the main video signal for generating the main picture data while depression of hot key F2 causes processing unit 438 to select computer C2 as the main video source.

Lists 442 and 444 define the assignment of hot keys to the computers C1, C2 and C3 to cause processing unit 438 to enable selecting of the first auxiliary video signal and the second auxiliary video signal for generating the respective auxiliary picture data, respectively. For example depression of hot key F5 causes processing unit 438 to enable selection of computer C2 as the video source for the first auxiliary video signal and depression of hot key F9 causes unit 438 to enable selection of computer C3 as the video source for the second auxiliary video signal.

The inputs performed on keyboard 434 are monitored by processing unit 438 under the control of program 439. Processing unit 438 checks the signal KB for any of the hot keys defined in lists 440, 442 and 444. Upon selection of a main video source by depressing one of the hot keys F1, F2 or F3 processing unit 438 derives a corresponding ‘Main’ signal that is coupled as a control signal to multiplexer 446.

Multiplexer 446, when activated by the ‘Main’ signal, switches the signals M and KB that switch 436 outputs in response to signals from inputs 428 and 432 to the respective keyboard and mouse inputs 450, 452, 454, 456, 458, 460 of one the computers C1, C2 or C3 which has been selected as the source for the main video signal. In this way, the inputs resulting from activation of computer mouse 430 and keyboard 434 are routed to the selected computer. In addition, the selection of the main and auxiliary video sources can be performed by activating control switch 448. Signal ‘CS’ coupled from control switch 448 to KVM switch 436 is 00 when computer C1 is selected as the main video source by activating control switch 448; signal CS is 01, if computer C1 is selected and 10, if computer C3 is selected.

In operation a user selects one of the computers C1, C2 or C3 as the source for the main video signal for generating the main picture data. This is done by pressing one of the predefined hot keys F1, F2 or F3 on keyboard 434. Likewise one of computers C1, C2 and C3 is selected as the first auxiliary video source and as the second auxiliary video source for generating the respective auxiliary picture data. Alternatively the selection of the main and auxiliary video sources can be performed by activating control switch 448.

In response to the selection of one of the computers C1, C2 and C3 as a main video source, processing unit 438 causes the control signal ‘main’ to be derived from KVM switch 436 such that the M and KB signals from computer mouse 430 and keyboard 434 are routed to one of the computers C1, C2 or C3 which has been selected as the main video source.

The signal ‘main’ is also supplied from KVM switch 436 to processing unit 414. Likewise processor 438 causes the signals ‘Aux1’ and ‘Aux2’ to be supplied from KVM switch 436 to processor unit 414. Processing unit 414 responds to signals ‘Aux1’ and ‘Aux2’ to control which one of the computers C1, C2 and C3 is selected as the first auxiliary video source and which one is selected as the second auxiliary video source.

For example, when the user has depressed hot keys F1, F5 and F9, computer C1 is the main video source, computer C2 is the source for the first auxiliary video signal and computer C3 is the source for the second auxiliary video signal. The signals M and KB are routed through multiplexer 446 to computer C1.

In the example, processing unit 414 generates main picture data for storage in the storage area 418 from the data which is buffered in video buffer 409. Likewise the data of video buffer 411 is used for generating the auxiliary picture data for storage in storage area 422 and the data of buffer 413 is used for generating the auxiliary picture data for storage in storage area 424. This way a combined display is provided on display unit 426. To change the assignments of computer C1, C2 and C3 to the main and auxiliary pictures the user can depress corresponding hot keys on keyboard 434 or use control switch 448.

Alternatively the selection of one of the computers C1, C2, or C3 can be done by activating computer mouse 430. In such a case, processor 462 of KVM-switch 436 responds to program 463 in its memory to receive signal M of computer mouse 430 from input 428. Further KVM-switch 436 is coupled to image storage 420 for accessing the bit-mapped combined image data including the main and auxiliary image data. On this basis processor 462 can determine where the mouse pointer of computer mouse 430 is located on the display. When the mouse pointer is located over the main picture, no action by program 462 occurs. When processor 462 detects that the mouse pointer is moved outside the main picture, processor 464 is invoked to generate image data for the mouse pointer.

This image data for the mouse pointer Is stored In image storage 420 in the respective storage area 422 or 424 of the auxiliary image, to which the mouse pointer is moved by the user. When the user clicks on one of the mouse buttons of computer mouse 430 the corresponding input signal N is captured by processor 462.

In response, processor 462 responds to program 463 to select the auxiliary image to which the mouse pointer has been moved as the main picture, in order to replace the current main picture. In order to replace the current main picture by the selected auxiliary picture, processor 462 outputs a corresponding main signal such that multiplexer 464 performs the necessary switching operation for the signals M and KB.

In addition, an on-screen menu of computer monitor 400 can also be controlled by computer mouse 430. For example, a user can invoke the on-screen control menu of computer monitor 400 to adjust brightness or contrast of the display by depressing one of the control switches 448 of computer monitor 400. In response, a window including the on-screen menu is displayed on display unit 426 of computer monitor 400.

When the mouse pointer is moved over the window including the on-screen menu, the image data for the mouse pointer is generated by processor 464 as is the case when the mouse pointer is moved outside the main picture. When the mouse pointer is over the window with the on-screen menu any input actions performed by the user by activating computer mouse 430 and/or keyboard 434 are related to that on-screen menu to perform the desired setting of the display parameters.

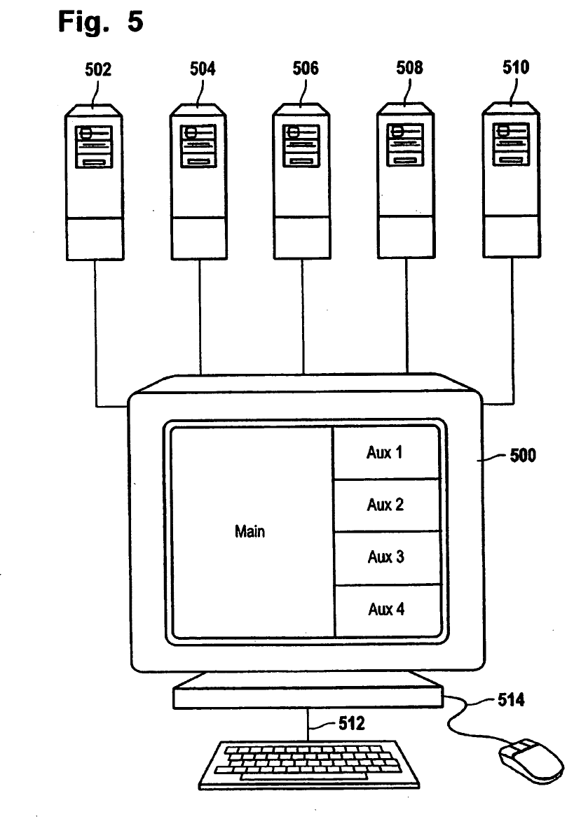

It is to be noted that the present invention is not restricted to a particular number of computers which are connected to the computer monitor. FIG. 5 is a diagram of an exemplary arrangement where five computers 502 to 510 are coupled to the same computer monitor 500. Computer monitor 500 operates in a picture-outside-picture mode. This means that the auxiliary images ‘aux1’, ‘aux2’, ‘aux3’, and ‘aux4’ are displayed simultaneously with the main picture, outside the main picture. Each one of the main and auxiliary pictures is assigned to one of the computers 502 to 510. In addition keyboard output 512 and mouse output 514 are routed through computer monitor 500 to the one of the computers 502 to 510 which has been selected as the video source for the main picture. The computer monitor 500 also supports the mode picture-in-picture display. The user can change from picture-outside-picture display mode to the picture-in-picture display mode by performing a predefined input action, e.g. by pressing a corresponding hot-key.

While there have been described and illustrated specific embodiments of the invention, it will be clear that variations in the details of the embodiments specifically illustrated and described may be made without departing from the true spirit and scope of the invention as defined in the appended claims. For example, the several processors and memories storing the several programs of FIG. 4 can be combined into a single processor and a single memory.

1. (canceled)

2. A computer monitor comprising:
inputs adapted to be responsive to at least first and second computer video signals,
a processing arrangement for assigning one of the at least first and second video signals to a main picture and for assigning another one of the, at least first and second video signals to an auxiliary picture,
an output adapted to simultaneously supply the main picture and the auxiliary picture to a single display, and
a mechanical input selection switch on a housing of the computer monitor for controlling assigning by the processing arrangement.

3. The computer monitor of claim 2, wherein the output is adapted to cause the display to generate the auxiliary image as a picture-in-picture of the main image.

4. A computer monitor comprising:
inputs adapted to be responsive to at least first and second computer video signals,
a processing arrangement for assigning one of the at least first and second video signals to a main picture and for assigning another one of the at least first and second video signals to an auxiliary picture, and
an output adapted to simultaneously supply the main picture and the auxiliary picture to a single-display, the output being adapted to cause the display to generate the auxiliary image as a picture-outside-picture next to the main picture.

5. The computer monitor of claim 4, further including a user selectable picture-in-picture and a picture-outside-picture display mode.

6. The computer monitor of claim 2, further comprising a connecting arrangement for coupling at least one computer peripheral to the monitor and for coupling the at least one computer peripheral to a computer providing the one of the at least first and second video signals being assigned to the main picture.

7. The computer monitor of claim 35, wherein the arrangement for coupling comprises a peripheral switch, the peripheral switch being adapted to generate a control signal for the assignment of the one of the at least first and second video signals to the main picture and for the assignment of the another one of the at least first and second video signals to the auxiliary picture.

8. The computer monitor of claim 7, wherein the peripheral switch is a KVM switch, the KVM switch being adapted to provide the control signal in response to a user command being inputted to the monitor to change the assignment of the at least first and second video signals to the main picture and the auxiliary picture.

9. The computer monitor of claim 8, wherein the KVM switch is adapted to receive the user command from a keyboard adapted to be coupled to the monitor.

10. A method of displaying multiple computer video output signals on a single display, the method comprising the steps of:
assigning one of the multiple computer video input signals to a first picture,
assigning at least one of the multiple computer video input signals to at least a second picture,
simultaneously displaying the combined first and second pictures on a single display; and
displaying the first picture and the at least one second picture by selecting a picture-in-picture display mode in a first instance and a picture-outside-picture display mode in a second instance.

11. The method of claim 10, wherein the assignment of one of the multiple computer video input signals to the first picture and the assignment of the one of the multiple computer video input signals to the second picture is performed by operating a mechanical input selection switch integrated in a housing of the single display.

12. The method of claim 10, wherein the steps of assigning one of the multiple computer video input signals is performed by activating a KVM switch integrated in a housing of the single display.

13. The method of claim 10, further comprising coupling a computer peripheral to the single display to a computer supplying the one of the multiple computer video input signals being assigned to the first picture.

14. (canceled)

15. A method of controlling a computer monitor comprising:
receiving a control signal that assigns one of multiple computer video input signals to a main picture and assigns at least one of the multiple computer video input signals to at least one auxiliary picture,
combining the first picture and the at least one second picture, and
storing the combined first picture and at least one second picture.

16. The method of claim 15, further including causing the computer monitor to receive the control signal from a mechanical input selection switch.

17. The method of claim 15, further including causing the computer monitor to receive the control signal from a KVM switch.

18-19. (canceled)

20. A display unit for displaying a combined image comprising multiple pictures, the display unit comprising:
a receiver for a plurality of computer video signals,
a selector for one of the plurality of computer video signals as a main signal,
a digital signal processor for generating (a) the first picture on the basis of the selected one of the plurality of computer video signals, (by at least one second picture on the basis of another one of the plurality of the computer video signals, and (c) combining the first picture and the at least one second picture, and
a memory including a single frame buffer for storing and enabling display by the display unit of a combined first picture and at least one second picture.

21. The display unit of claim 20, further comprising a first interface for coupling at least one computer peripheral to the display unit and a second interface for coupling the at least one peripheral to a computer for deriving the selected one of the computer video signals.

22. The display unit of claim 20, further comprising a KVM switching component for coupling the computer peripheral to the computer.

23. The display unit of claim 22, wherein the KVM switching component is adapted to be controlled by a user performing a user input action by activating the at least one computer peripheral.

24. The display unit of claim 22, wherein the KVM switching component is a KVMP switching component.

25. The display unit of claim 20, wherein the first picture is a main picture, and each of the at least one second pictures is an auxiliary picture, and the selector is adapted to (a) determine if a mouse pointer is moved outside the main picture to one of the auxiliary pictures, and (b) select the one of the auxiliary pictures as the main picture in response to a user performing a mouse input action.

26. The display unit of claim 25, further comprising a generator of image data for display of the mouse pointer, the generator of image data for display of the mouse pointer being coupled to the selector, and the selector being adapted to invoke the generator of image data for display of the mouse pointer in response to the mouse pointer being moved outside the main picture.

27. The display unit of claim 25, wherein the generator of image data for display of the mouse pointer is adapted to generate image data for display of the mouse pointer in response to the mouse pointer being moved to an on-screen menu.

28. A computer monitor having:
first and second video inputs connectable to outputs from first and second computers;
at least one input for receiving a signal from a peripheral device; and
a switch connected to the peripheral device input and adapted to select, on the basis of the signal from the peripheral device, one of the first and second images as an active image, and to route the signal from the peripheral device to the computer having an active image.

29-34. (canceled)

35. The computer monitor of claim 4, further comprising a connecting arrangement for coupling at least one computer peripheral to the monitor and for coupling the at least one computer peripheral to a computer providing the one of the at least first and second video signals being assigned to the main picture.

36. An article of manufacture for controlling a computer monitor for causing the steps of claim 15 to be performed.

37. A display unit for displaying a combined image comprising multiple pictures, the display unit comprising:
a receiver for a plurality of computer video signals,
a selector for one of the plurality of computer video signals as a first signal,
a digital signal processor for generating (a) a main picture on the basis of the selected one of the plurality of computer video signals, (b) at least one auxiliary picture on the basis of another one of the plurality of the computer video signals, and (c) combining the main picture and the at least one auxiliary picture, and
the selector being arranged to (a) determine if a mouse pointer is moved outside the main picture to one of the auxiliary pictures and (b) select one of the auxiliary pictures as the main picture in response to a user performing a mouse input action, and
a display coupled with the signal processor for simultaneously displaying the main picture and at least one auxiliary picture.

38. The display unit of claim 37, further comprising a generator of image data for display of the mouse pointer, the generator of image data for display of the mouse pointer being coupled to the selector, and the selector being adapted to invoke the generator of image data for display of the mouse pointer in response to the mouse pointer being moved outside the first picture.

39. The display unit of claim 38, wherein the generator of image data for display of the mouse pointer is adapted to generate image data for display of the mouse pointer in response to the mouse pointer being moved to an on-screen menu.
